(19) United States
(12) Patent Application Publication
(10) Pub. No.: US 2007/0137850 A1
(43) Pub. Date: Jun. 21, 2007

(54) Vehicle heating and/or air conditioning system and a method for regulating heating and/or air conditioning in vehicles

(76) Inventor: Wolfgang Straub, Deggingen (DE)

Correspondence Address: KENYON & KENYON LLP, ONE BROADWAY, NEW YORK, NY, 10004, US

(21) Appl. No.: 10/558,864

(22) PCT Filed: Apr. 27, 2004
(86) PCT No.: PCT/EP04/04424

§ 371 Date: Dec. 15, 2006

(30) Foreign Application Priority Data
May 30, 2003 (DE) 103 24 571.5

(51) Int. Cl. B60H 1/00

(52) U.S. Cl. 165/202

(57) ABSTRACT

A vehicle heating and/or air conditioning system and a method for regulating heating and/or air conditioning in vehicles permit a user, in a fully automatic operating mode, to adapt a blower power and air distributor flaps in accordance with this individual sensation of a draft without resulting in the automatic operating mode being exited. For this purpose, the vehicle heating and/or air conditioning system has a setting device on which the user may make settings. The set value of this setting device is transmitted to an automatic heating and/or air conditioning device which selects adapted automatic characteristic curves corresponding to this set value and actuates the blower and the air distributor flaps in accordance with these adapted automatic characteristic curves. It is optionally possible for a decision device to be provided in the automatic air conditioning device, the decision device making a decision as to whether a heating mode (winter) or a ventilation mode or cooling mode (summer) is occurring, and multiplying set values in the ventilation mode by a predefined factor which is greater than 1 before the adapted automatic characteristic curves are selected, in order to allow for the increased sensation of a draft in the ventilation mode.

### FIELD OF THE INVENTION

The present invention relates to a vehicle heating and/or air conditioning system and to a method for regulating heating and/or air conditioning in vehicles.

### BACKGROUND INFORMATION

Vehicle air conditioning systems conventionally have one or more automatic pushbutton keys. If the automatic air conditioning system is activated, the entire air conditioning actuator system such as the blower, flaps, etc., is automatically open-loop or closed-loop controlled. This open-loop or closed-loop control is a permanently stored program which the user cannot change. If a user is not satisfied with the automatic function stored in the program, all that he can do with conventional air conditioning systems is to switch off the automatic air conditioning system and set the blower and/or the air flaps manually. This may have disadvantageous effects on the user's comfort.

German Published Patent Application No. 101 03 129 describes a method for setting a heating and/or air conditioning system which has a regulating system which is controlled by the temperature of the passenger compartment and which adjusts the actual value of the temperature of the passenger compartment to the setpoint value of the temperature of the passenger compartment which has been set on an operator control unit. In this context, a blower is provided which feeds the air-conditioned air to the passenger compartment of the vehicle. In the controlled state or when the temperature setpoint value is adjusted, the blower power is raised for a chronologically predetermined period. In this context, a blower characteristic curve is used which is dependent on the ambient temperature, intensity of the sun, set air distribution and on country-specific codes. At a raised level of intensity of the sun the blower power is increased to a relatively large extent.

However, with this method for automatically regulating heating and/or air conditioning, the user also only has the possibility of changing the temperature setpoint value. There is no further possibility for intervention if an automatic operating mode is desired.

Furthermore, German Published Patent Application No. 196 09 589 describes a vehicle heating and/or air conditioning system in which the desired temperature or blowing-out temperature of the air stream which is introduced into various layered zones of the passenger compartment of the vehicle, for example, head space, torso area and foot well, can be set for these layered zones. The air conditioning air quantity which is assigned to the individual layered zones is determined by an automatic program. There is also no possibility of intervening to regulate the blower power in accordance with individual preferences.

German Published Patent Application No. 198 48 658 describes a vehicle heating and/or air conditioning system which is modified with respect to the vehicle heating and/or air conditioning system described in German Published Patent Application No. 196 09 589 to the effect that the temperature of the entire passenger compartment is set by a centralized setting facility, while the adaptation to the individual sensation of comfort of individual vehicle occupants is carried out by influencing the layered zones which are assigned to these occupants. In this context, the user specifies a difference between the desired temperature and the set temperature for the entire passenger compartment. An automatic program converts this individual temperature setting into a air quantity control, predefined by characteristic diagrams, for the individual main blowing-out levels, i.e., either an enhanced, cooling air stream or a reduced, warming air stream is introduced as a function of the current temperature conditions. However, with this vehicle heating and/or air conditioning system, it is also impossible to regulate the blower power in accordance with individual preferences.

Accordingly, with conventional air conditioning systems the user can only influence the air conditioning either by changing the predefined temperature directly or indirectly, i.e., by predefining a differential value, or by directly intervening with the air distribution or the blower, which is equal to exiting the automatic program, since it is conventional that the air distribution and the blower power of an automatic air conditioning program change when a different temperature is predefined.

However, conventional systems do not include any method or device for regulating air conditioning with which personal preferences of the user with respect to the blower power in the automatic operating mode, for example, whether a user is extremely sensitive to drafts and therefore generally desires a reduced blower power, or whether a user is very willing to use a strong blower power without feeling adversely affected by the strong draft, can be taken into account, i.e., in which the method of operation is “seemingly adjustable” by the operator without the temperature setting having to be changed or the blower or the air distributor flaps having to be adapted and the automatic function thus having to be deactivated.

### SUMMARY

An example embodiment of the present invention may provide a vehicle heating and/or air conditioning system and a method for regulating heating and/or air conditioning in vehicles such that the user may adapt or influence the automatic sequences of the regulating of the air conditioning by at least one settable parameter without there being a need to switch off to manual operating mode, and, e.g., the user may generally adapt the blower power in accordance with his requirements without having to exit the automatic operating mode.

Since, with the vehicle heating and/or air conditioning system and with the method for regulating heating and/or air conditioning in vehicles, it is possible to influence at least one parameter, or to carry out an adaptation, such that the automatic sequences change during an automatic air conditioning regulating process, the automatic air conditioning regulating process may be set in accordance with the wishes of the user without the need to switch over to a completely manual operating mode so that, depending on the wishes of the user, it is possible, for example, to provide draft-free, diffuse cooling in summer or strong, very direct cooling in summer.

This and further features and aspects hereof are apparent from the following description with reference to the appended Figures.

### BRIEF DESCRIPTION OF THE DRAWINGS

FIG. 1 is a block circuit diagram of a vehicle heating and/or air conditioning system according to an example embodiment of the present invention.

FIG. 2 is a flowchart illustrating a method according to an example embodiment of the present invention for regulating heating and/or air conditioning in motor vehicles.

### DETAILED DESCRIPTION

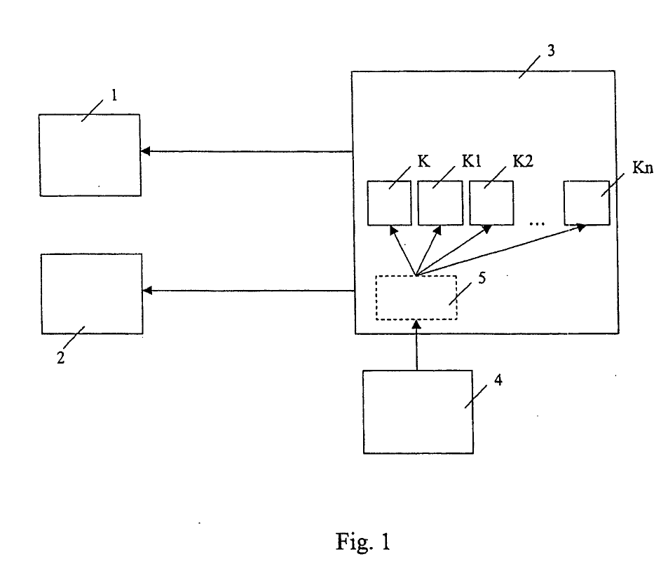

First, the design and the method of functioning of the vehicle heating and/or air conditioning system according to an example embodiment of the present invention will be explained in more detail below with reference to FIG. 1.

FIG. 1 is a block circuit diagram of a vehicle heating and/or air conditioning system in which only the components which may be needed for understanding are illustrated.

The vehicle heating and/or air conditioning system includes a blower 1 and air distributor flaps 2 which are actuated by an automatic heating and/or air conditioning device 3.

This automatic heating and/or air conditioning device 3 is activated by activating, for example, an operator control switch in the vehicle and then carries out a fully automatic regulating process of the heating and/or of the air conditioning of the passenger compartment of the vehicle in accordance with an automatic characteristic curves K stored in the automatic heating and air conditioning device 3. In addition, the vehicle heating and/or air conditioning system has a setting device 4 by which a user may influence at least one of the parameters used in the automatic characteristic curve K in the automatic heating and/or air conditioning device 3, i.e., may carry out adaptation in accordance with his personal requirements, e.g., the personal sensation of a draft, without deactivating the fully automatic regulating process, as is the case in conventional systems when the user influences the air distribution or the blower power.

This setting device 4 may be, for example, a rotary regulator, sliding switch, a submenu, etc., which may be set by the user himself. Alternatively, it is possible to form a setting device 4 which is formed in a diagnostic device in the vehicle and which may be accessed by an external diagnostic device such as, for example, a diagnostic computer, so that individual adaptation may be carried out only by a workshop, etc.

In the exemplary embodiment which is illustrated in FIG. 1 and in which a setting device 4 which may be set directly by the user is formed, it is possible to use the setting device 4 to influence the automatic characteristic curve with its preset parameters to regulate the blower behavior and the air distributor flaps, e.g., additional diffuser flaps of the cockpit vents. It is also possible to influence other parameters, such as, for example, temperature regulating parameters of a plurality of individual temperature setting zones, with the setting device 4 being arranged either as an individual setting unit which influences a combination of parameters, or being able to be composed of separate setting units for the respective parameters. In this manner, with the vehicle heating and/or air conditioning system hereof, it may be possible to ensure that, for example, when reducing the set value of the setting device in comparison with a predefined setting, which is generally assigned a “0” setting, a flatter actuation characteristic curve is used for the blower 1 and more rapid switching over of the air distributor flaps 2 from direct flow toward a person to a diffuse, distributed flow takes place. In contrast, when the set value of the setting device 4 is increased in comparison with the predefined setting “0”, a steeper actuation characteristic curve is used for the blower 1 and the switching over of the air distributor flaps 2 from direct flow toward a person to a diffuse, distributed flow takes place later. For this purpose, in accordance with an output signal which is transferred from the setting device 4 to the automatic heating and/or air conditioning device 3 and which corresponds to the value which has been set in the setting device 4, the automatic heating and/or air conditioning device 3 selects a corresponding, pre-stored automatic characteristic curve for actuating the blower 1 and the air distributor flaps 2.

Since, in the cooling mode or ventilation mode of the vehicle heating and/or air conditioning system in which the air emerges from cockpit vents, an individual sensation of a “draft” generally has a greater effect than in the heating mode when the greatest part of the air stream is directed at the legs, it is possible for a decision device 5 to be formed additionally in the vehicle heating and/or air conditioning system which decides whether a heating mode or a ventilation mode is occurring. In this context, an average blowing-in temperature, which predefines the heating or ventilation or cooling mode, is determined as a function of the external temperature, the solar radiation and by the control difference between the actual internal temperature and the average setpoint passenger compartment temperature which has been set.

The output signal is, or is not, amplified by this setting device 4 of the received signal in response to this decision as to whether a heating, ventilation or cooling mode is occurring. To be specific, if the decision device 5 has decided that a ventilation mode or cooling mode is occurring, the output signal is amplified by the setting device 4 so that an automatic characteristic curve K1 to Kn which is adapted to a greater degree than would have been the case directly from the set value is selected since the sensation of a “draught” has a considerably greater effect in the ventilation mode, while in the heating mode there is no change in the output signal received by the setting device 4 and there is thus a direct selection of adapted automatic characteristic curves K1 to Kn.

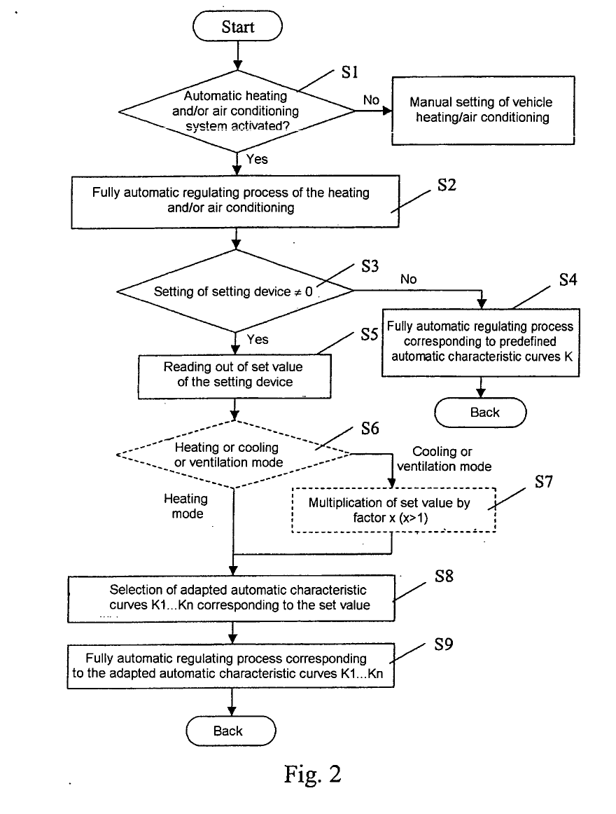

In the text which follows, a method for regulating heating and/or air conditioning in vehicles will be described in more details with reference to the flowchart in FIG. 2.

At the start of the method for regulating heating and/or air conditioning in vehicles, checking is carried out in step S1 to determine whether the automatic heating and/or air conditioning device 3 is activated. If this is not the case, the vehicle heating/air conditioning system is set manually and the sequence ends.

If it is detected in step S1 that the automatic heating and/or air conditioning device 3 is activated, a fully automatic regulating process of the heating and/or of the air conditioning takes place in step S2. In step S3, checking is carried out to determine whether a set value of the setting device 4 is not equal to zero, i.e., the user desires a deviation from the predefined value. If it is detected in step S3 that the set value is equal to 0, in step S4 a fully automatic regulating process of the heating and/or of the air conditioning is carried out in accordance with the predefined automatic characteristic curves K and the system then returns to the beginning again.

If, on the other hand, it is detected in step S3 that the set value of the setting device is not equal to zero, i.e., the user desires a deviation from the predefined value, in step S5 the set value of the setting device 4 is read out by the automatic heating and/or air conditioning device 3. Then, in step S8, an adapted automatic characteristic curve K1 to Kn is selected in accordance with the read-out set value, and in step S9 a fully automatic regulating process of the heating and/or of the air conditioning is then carried out in accordance with the selected automatic characteristic curve K1 to Kn. The system then returns to the beginning.

It is also optionally possible to insert, between step S5 and 88, a further step S6 which is represented by dashed lines in the flowchart in FIG. 2 and in which there is an interrogation to determine whether a heating mode or a ventilation mode is occurring. If a heating mode is occurring, i.e., in winter, the sequence continues directly to the selection of an adapted automatic characteristic curve K1 to Kn in accordance with the set value which has been read out in step S5, while in the case of a ventilation mode, i.e., in summer, the sequence branches and at first in a step S7 the set value, read out in step S5, of the set device 4 is multiplied by a factor x (x>1) and the selection of the adapted automatic characteristic curve K1 to Kn is then made in step S8 using the set value calculated in step S7. This multiplication of the set value by the factor x in step S7 occurs because the individual sensation of a “draught” in the ventilation mode has a greater effect than in the heating mode if the greatest part of the air stream is directed at the legs and it is thus possible to accommodate better the setting wishes of the user so that a change in setting may be perceived by him.

In this manner, with the method for regulating heating and air conditioning in vehicles, it may be possible to ensure that a user may bring about individual adaptation of the blower power and of the air distribution without, as is conventionally necessary, having to switch over to a manual operating mode. For this reason, a heating and/or air conditioning system which is adapted to the passenger compartment temperature and sensed ambient conditions and which additionally corresponds to the individual requirements of the user without manual (re)adjustment being required may be obtained.

Examples of the blower behavior and the setting of diffuser flaps of the cockpit vents for various set values of the setting device 4 is additionally explained in more detail below, with a distinction additionally being made as to whether a heating mode (winter) or a ventilation mode or cooling mode (summer) is occurring and the diffuser flaps of the cockpit vents are actuated only in the ventilation mode or cooling mode (summer). A setting device 4 with set values from −3 to +3 is used, with both the blower behavior and the diffuser flaps of the cockpit vents being actuated in accordance with the set value. However, it is also possible to use a plurality of setting devices 4 as well as one or more setting devices 4, for example, for separately influencing the blower behavior and diffuser flaps of the cockpit vents, with different set values.

First, details will be given on the actuation of the diffuser flaps of the cockpit vents 2 for the various set values of the setting device 4. At the minimum set value of the setting device 4, i.e., in the example of the set value −3, the diffuser flaps of the cockpit vents 2 are always opened so that a diffuse, distributed flow is obtained. In contrast, at the maximum set value of the setting device 4, i.e., in the case of a set value +3, the diffuser flaps of the cockpit vents 2 are always closed in order to bring about direct flow toward a person. At the other set values of the setting device, i.e., at values from −2 to +2, the diffuser flaps of the cockpit vents 2 are controlled such that direct or indirect flow toward a person corresponding to the predefined wish is brought about. Depending on the respective set value of the setting device 4, the diffuser flaps of the cockpit vents 2 are then opened as soon as the actual passenger compartment temperature is within a predetermined interval above the setpoint temperature, for example, at the set value −2 from 30K above the setpoint temperature, at the set value −1 from 20K above the setpoint temperature, at the set value 0 from 10K above the setpoint temperature, at the set value +1 from 5K above the setpoint temperature and at the set value +2 from the time at which the actual passenger compartment temperature is equal to the setpoint passenger compartment temperature. Since the opening time of the diffuser flaps of the cockpit vents 2 is later, i.e., closer to the setpoint temperature to be achieved, the greater the set value of the setting device 4, it may be ensured that at small set values switching over already occurs very early from a direct flow toward a person to a diffuse, distributed flow, while this only occurs very late in the case of large set values, or does not occur at all at the maximum set value. A correspondence is thus brought about with the user's sensation of a draft.

Furthermore, the blower behavior is adapted in accordance with the sensed set value of the setting device 4 and the present operating mode, i.e., heating mode (winter) or ventilation mode or cooling mode (summer) since the sensation of a draft is greater in summer, also due to the different flow of the user in these two operating modes.

In summer, i.e., in the ventilation mode, a change occurs in accordance with the selected set value of the setting device 4 starting from a basic setting, i.e., the set value 0 at which the blower operates as a function of the sun, with average blower run-up time, a normal blower basic level and in accordance with a blower automatic curve. In this context, at positive set values of the setting device 4 the blower automatic curve is made steeper, the blower basic level and the dependence on the sun are increased all the more and the blower run-up time is reduced all the more the higher the set value selected. In contrast, in the case of negative set values of the setting device 4 the automatic blower curve is made flatter, the blower basic level and the dependence on the sun are reduced all the more and the blower run-up time is raised all the more. In this manner, at relatively high set values of the setting device 4 faster, stronger ventilation is brought about than in the basic setting, and at relatively low set values of the setting device 4 slower, weaker ventilation is brought about, which correspond more to the user's respective sensation of a draft than the basic setting, due to the user's selected setting of the setting device 4.

In contrast, in winter the blower is actuated in a modified fashion compared to summer since in the heating mode the greatest part of the air stream is directed at the legs and the individual sensation of a draft is thus lower and in addition the solar radiation is less intense in winter so that it may not need to be taken into account to such a large extent. In addition, in winter, a distinction is made between cold starting and warm starting. In the basic setting, the actuation of the blower takes place in the case of a cold start, as in summer, in accordance with a normal automatic blower curve with a normal blower rise curve (as a function of the feed temperature of the heating water) but with less solar dependence owing to the lower solar intensity. In the case of a warm start, the blower operating mode occurs with a predetermined delay (blower run-up time) in order to bring about a gentle run-up behavior of the heater.

The higher the set value of the setting device 4 is selected above the basic setting (set value 0), the steeper the automatic blower curve for actuating the blower is selected, but the rise in the gradient per set value is lower, by a factor x, than in the summer operating mode. Likewise, in the winter operating mode, as the set value increases, the basic level and the solar dependence are increased even further, and in the case of a warm start the blower run-up time is also reduced even further, with this being reduced by a factor x compared to the summer operating mode.

Conversely, in the case of the winter operating mode, the automatic blower curve for actuating the blower becomes increasingly flat as an increasingly low set value of the setting device 4 is selected below the basic setting (set value 0), but this decrease is lower by a factor x than in the summer operating mode. Likewise, in the winter operating mode as the set value decreases the basic level and the solar dependence are reduced eyen further, and in the case of a warm start the blower run-up time is also increased ever further, with this being reduced by a factor x compared to the summer operating mode. The automatic blower curve for actuating the blower becomes increasingly flat as an increasingly low set value of the setting device 4 is selected below the basic setting (set value 0). The drop in the gradient perset value is also lower than in the summer operating mode.

As a result, it is particularly the differentiation between the summer and winter operating modes which makes it possible for a user's different sensation of a draft in the heating mode and in the ventilation mode to be taken into account.

1-10. (canceled)

11. A vehicle heating/air conditioning system, comprising:
an automatic heating/air conditioning device adapted to regulate, in accordance with at least one setpoint passenger compartment temperature presettable by a user, an actual passenger compartment temperature by automatic regulation of at least one blower and air distributor flap in accordance with predefined automatic characteristic curves; and
at least one setting device adapted to select other automatic characteristic curves adapted to a user's individual sensation of a draft.

12. The system according to claim 11, further comprising a decision device adapted to decide whether one of (a) a heating mode, (b) a ventilation mode and (c) a cooling mode is occurring and to process a signal from the setting device in response to the decision by the decision device to amplify a change in setting in one of (a) the ventilation mode and (b) the cooling mode by a predetermined factor with respect to a change in setting in the heating mode, the decision device adapted to select automatic characteristic curves in accordance with the amplified change in setting.

13. The system according to claim 12, wherein the predetermined factor is determined from a characteristic diagram as a function of one of (a) a heating power and (b) a cooling power.

14. The system according to claim 11, wherein the setting device is adapted to make a selection of adapted automatic characteristic curves to actuate the blower and the air distributor flaps in response to a setting selected by the user.

15. The system according to claim 11, wherein the setting device includes one of (a) a rotary regulator, (b) a slide switch and (c) a submenu adapted to influence one of (a) a parameter and (b) a combination of parameters of the automatic heating/air conditioning device.

16. The system according to claim 11, wherein the setting device is arranged in a diagnostic device that is actuatable by an external diagnostic device and that is adapted to influence one of (a) a parameter and (b) a combination of parameters of the automatic heating/air conditioning device.

17. The system according to claim 11, wherein the setting device includes a plurality of setting units, each setting unit adapted to influence one of (a) a parameter and (b) a combination of parameters of the automatic heating/air conditioning device.

18. The system according to claim 11, wherein when negative et values are set by the setting device, instead of predefined automatic characteristic curves, the automatic characteristic curves for actuating the blower with a flatter profile and faster switching over of the air distributor flaps from direct flow towards a person to a diffuse, distributor flow are selected, and when positive set values are set by the setting device, instead of the predefined automatic characteristic curves, the automatic characteristic curves for actuating the blower with a steeper profile and slower switching over of the air distributor flaps from direct flow toward a person to a diffuse, distributed flow are selected.

19. A method for regulating at least one of (a) heating and (b) air conditioning in a vehicle heating/air conditioning system, comprising:
(a) checking to determine whether an automatic heating/air conditioning device of the vehicle heating/air conditioning system is activated, the automatic heating/air conditioning device adapted to regulate, in accordance with at least one setpoint passenger compartment temperature presettable by a user, an actual passenger compartment temperature by automatic regulation of at least one blower and air distributor flap in accordance with predefined automatic characteristic curves, and, if the automatic heating/air conditioning device is not activated, performing a manual setting of the vehicle heating/air conditioning system and ending the method;
(b) if it is detected in step (a) that the automatic heating/air conditioning device is activated, fully automatically regulating the at least one of (a) the heating and (b) the air conditioning;
(c) checking to determine whether a set value of a setting device of the automatic heating/air conditioning device is unequal to zero, the adapted to select automatic characteristic curves adapted to a user's individual sensation of a draft;
(d) if it is determined in step (c) that the set value is equal to zero, fully automatically regulating the at least one of (a) the heating and (b) the air conditioning in accordance with predefined automatic characteristic curves and restarting the method;
(e) if it is determined in step (c) that the set value is unequal to zero, reading out the set value by the automatic heating/air conditioning device;
(f) selecting adapted automatic characteristic curves in accordance with the read-out set value; and
(g) fully automatically regulating the at least one of (a) the heating and (b) the air conditioning in accordance with the selected automatic characteristic curves and restarting the method.

20. The method according to claim 19, further comprising:
(h) between steps (e) and (g), performing an interrogation to determine whether one of (a) a heating mode, (b) a ventilation mode and (c) a cooling mode is occurring, if the heating mode is occurring, performing step (f) to s select adapted automatic characteristic curves in accordance with the set value read out in step (e); and
(i) if one of (a) the ventilation mode and (b) the cooling mode is occurring, multiplying the set value read out in step (e) by a factor greater than 1, and selecting adapted automatic characteristic curves in step (f) using the set value calculated in step (i).
